(19) United States
(12) Patent Application Publication
(10) Pub. No.: US 2005/0138400 A1
(43) Pub. Date: Jun. 23, 2005

(54) Digital content protection method

(75) Inventors: Cheng-Han Wu, Taipei City (TW); Chang-Chin Tsao, Yuanlin Township (TW); Jian-Wei Huang, Gukeng Township (TW)

Correspondence Address: BACON & THOMAS, PLLC, 625 SLATERS LANE, FOURTH FLOOR, ALEXANDRIA, VA, 22314, US

(73) Assignee: Institute For Information Industry, Taipei (TW)

(21) Appl. No.: 10/851,059

(22) Filed: May 24, 2004

(30) Foreign Application Priority Data
Dec. 19, 2003 (TW) 092136279

(51) Int. Cl. H04L 9/00

(52) U.S. Cl. 713/189

(57) ABSTRACT

A digital content protection method applied in a digital rights management (DRM) system is provided. A software identification certification authority issues an identification certification for the player and the user agent and embeds a verification program in the digital content provided by a content provider. When an end user executes the digital content, the verification program will be started to verify the validity of the player and the user agent. When all elements are verified, the user agent can control the player to execute the digital content according to the definition of the right permission to protect the right and interest for the content provider.

### BACKGROUND OF THE INVENTION

1. Field of the Invention

The present invention relates to a digital content protection method, which is applied in the technical field of a digital rights management (DRM) mechanism.

2. Description of the Related Art

Currently, due to the increasing popularity of networking technology, information transmission speeds have increased substantially, resulting in the more vigorous and convenient circulation of information. However, enormous amounts of information can be spread about. The ease of content reproduction is seen in the downloading of MP3 music files, valuable articles and pictures. All of this content can be sent to other end users, and the unrestricted spread and reproduction of this information devalues the information. Therefore, digital rights management (DRM) mechanisms are provided, which encrypt digital content and right authorizations, to safely exchange digital media content through the Internet, or via other media, to protect the content provider's rights and interests.

However, in the prior art digital rights management mechanism standard, there exists no specific content access protection. The standard simply roughly defines if the digital rights management mechanism can control access contents and access rights. As there is no clear specification description, valuable content may be illegally used, reproduced and transmitted, which defeats content protection for the provider's rights and security. For example, a prior art structure is frequently embedded within a mobile phone or in a user agent (UA) managed by a user; however, the validity of such a structure may have been queried for a long time. Furthermore, it is not easy to control valid access rights for the digital content, since the prior art structure can be moved and executed in other devices, which can entail security problems.

Therefore, it is desirable to provide a digital content protection method to mitigate and/or obviate the aforementioned problems.

### SUMMARY OF THE INVENTION

A main objective of the present invention is to provide a digital content protection method; the digital content comprises a verification program to implement an identification certification process to ensure that every usage is valid. Since the verification program is provided by the content provider, the content provider's rights and interests are protected completely.

Another objective of the present invention is to provide a digital content protection method, which verifies the validity of the user agent and the player to ensure the valuable content cannot be illegally reproduced or spread.

According to the present invention, a digital content protection method applied in a digital rights management (DRM) system is provided, the digital rights management system includes a software provider, a software identification certification authority, a content provider, and an end user. The software provider provides at least one player for executing or rendering digital content, and a user agent for controlling a usage authority for the player and management of a public key and a secret key. The software identification certification authority issues an identification certification for the player and the user agent and confirming the identity of the player and the user agent. The content provider provides at least one piece of digital content for the end user to download, and the digital content containing a verification program for examining a validity of the player and the user agent.

The method of the present invention comprises: (A) issuing a software download request for downloading the user agent and its corresponding identification certification; (B) receiving the user agent, its corresponding identification certification and a public key corresponding to the user agent, wherein the user agent is embedded with a corresponding secret key; (C) sending a digital content request with a user identity of the user and the public key corresponding to the user agent; (D) receiving a digital content package comprising an encrypted package, an verification program and a user identification code of the end user, the encrypted package being digital content encrypted according to a public key of the user agent; and (E) examining the validity of the identification certification of the user agent according to the verification program and the validity identification certification of the player by the user agent, then using the secret key of the user agent to decrypt the encrypted package to combine the digital content with a right permission for regulating a use limitation of the digital content and to be played by the player.

Furthermore, the present invention includes a unit for issuing right permissions, which can be provided by an independent right issuer or by the content provider. In addition, depending upon different definitions of the practical environment, the present invention can issue the software download request to the software provider or to the software identification certification authority. The digital content can be valuable digital content or unvalued digital content.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a practical environment of a first embodiment according to the present invention;

FIG. 2 is a flowchart of the first embodiment according to the present invention;

FIG. 3 is a schematic drawing of a verification process of the first embodiment according the present invention;

FIG. 4 is schematic drawing of a practical environment of a second embodiment according to the present invention; and

FIG. 5 is a schematic drawing of a practical environment of a third embodiment according to the present invention.

### DETAILED DESCRIPTION OF THE PREFERRED EMBODIMENT

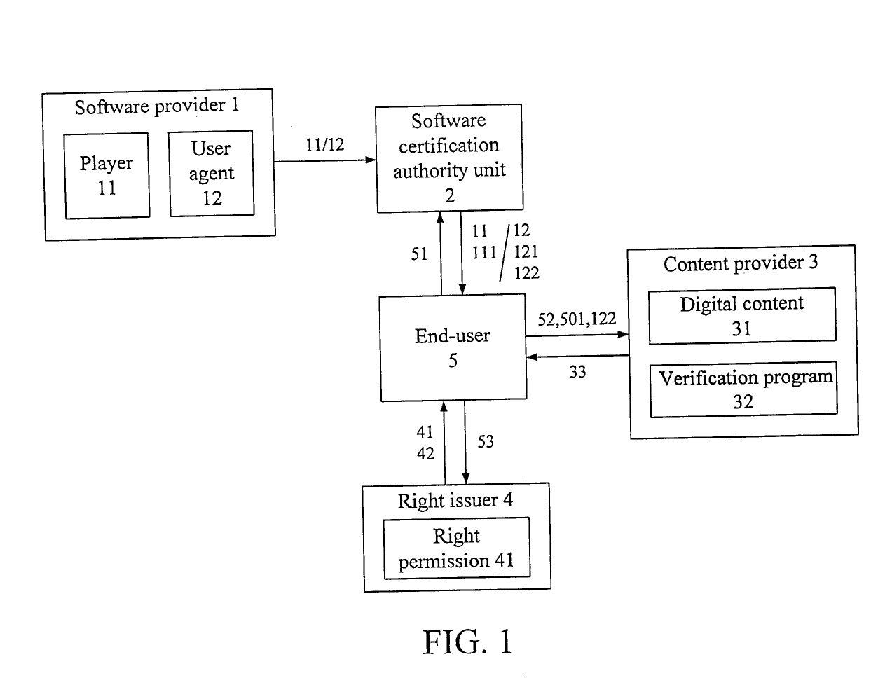

Please refer to FIG. 1. FIG. 1 is a schematic drawing of a practical environment of a first embodiment according to the present invention. In this embodiment, a digital rights management (DRM) system comprises a software provider 1, a software certification authority (CA) unit 2, a content provider 3, a right issuer 4 and an end user 5. The software provider 1 provides a player 11 for executing or rendering digital content and a user agent (UA) 12 for controlling usage authority of the player 11, such as an MPEG4 player, an MP3 player or a JPEG2000 browser. The user agent 12 can manage a public key and a secret key. The software certification authority unit 2 is a valid and authentic third party, which issues identification certifications, performs certifications, and certifies tasks for the player 11 and the user agent 12 in a networking environment. The content provider 3 provides at least one piece of valued or unvalued digital content 31 for the user to download, such as MP3 music files, articles, images or pictures, and digital content 31 is embedded with a verification program 32 for verifying the validity of the player 11 and the user agent 12 used by the end user 5. The right issuer 4 issues a corresponding right permission for the digital content 31 to control the usage authority of the digital content 31. In order to ensure information transmission security among every network element in the networking environment, this embodiment transmits information through the wireless transport layer security (WTLS) in the digital rights management system.

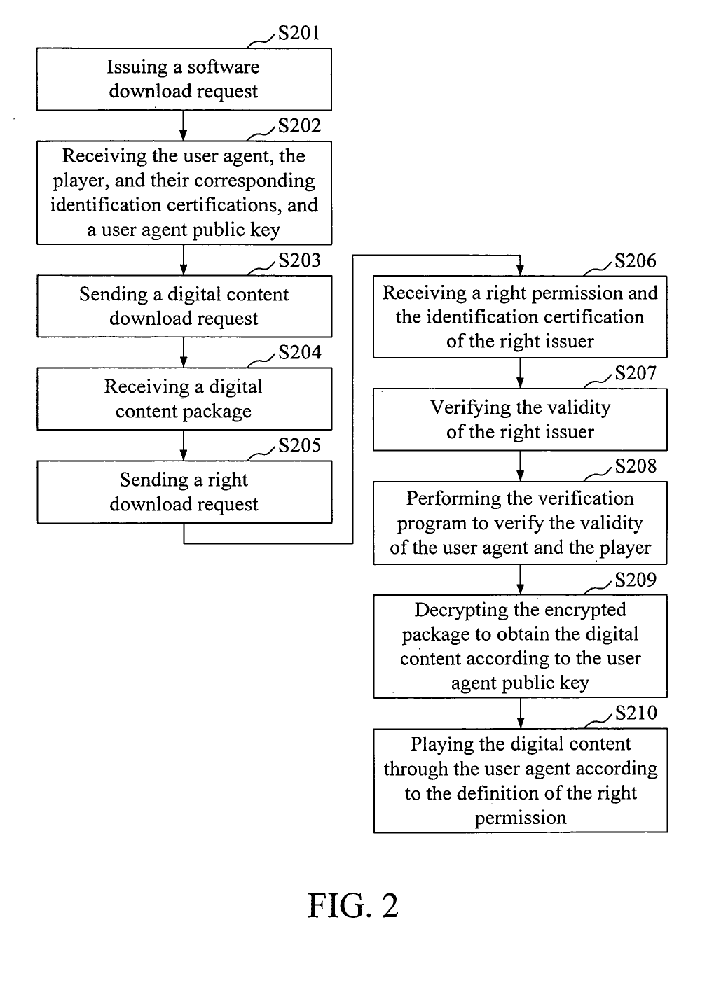

Please refer to FIG. 2. FIG. 2 is a flowchart of the first embodiment according to the present invention. The end user 5 needs first to be provided with the player 11 and the user agent 12, and can then use the digital content 31 provided by the content provider 3. Therefore, the end user 5 issues a software download request 51 to the software certification authority unit 2 to download the player 11 and the user agent 12 (step 201). Since the player 11 and the user agent 12 are both verified and issued with an identification certification by the software certification authority unit 2, the software certification authority unit 2 sends the player 11, the user agent 12 and their corresponding identification certifications 111, 121, and a user agent public key 122, to the end user 5 (step 202). If the end user 5 already has a valid user agent 12, the end user 5 only needs to download the player 11 and its corresponding identification certification 111. One thing to be noted is that a UA public key, UAₚₖ 122, is provided for the content provider 3 to encrypt the digital content 31; a UA secret key, UAₛₖ, is embedded in the user agent 12 and provided for later decrypting the encrypted digital content 31.

Next, the end user 5 sends a digital content download request 52 with a user identification code 501 and the UA public key UAₚₖ 122 to the content provider 3 (step 203). The content provider 3 sends back a digital content package 33 to the end user 5 according to the end user 5 (step 204). The user identification code 501 can be a subscriber identity module (SIM) number stored in a terminating machine of the end user 5, or a unique number for the end user 5 that represents the end user 5. The digital content package 33 comprises an encrypted package, a verification program 32 and the user identification code 501. The encrypted package is the digital content 31 encrypted by the UA public key UAₚₖ 122.

Since the digital rights management system defining the digital content can only be executed with corresponding right permissions, the end user 5 needs to send a right download request 53 to the right issuer 4 (step 205); afterwards, the right issuer 4 sends a right permission 41 with its identification certification 42 to the end user 5 (step 206). When the end user 5 receives the right permission 41 with its identification certification 42, the end user 5 can use a right issuer public key RIₚₖ provided by the software certification authority unit 2 to verify the validity of the right issuer 4 (step 207).

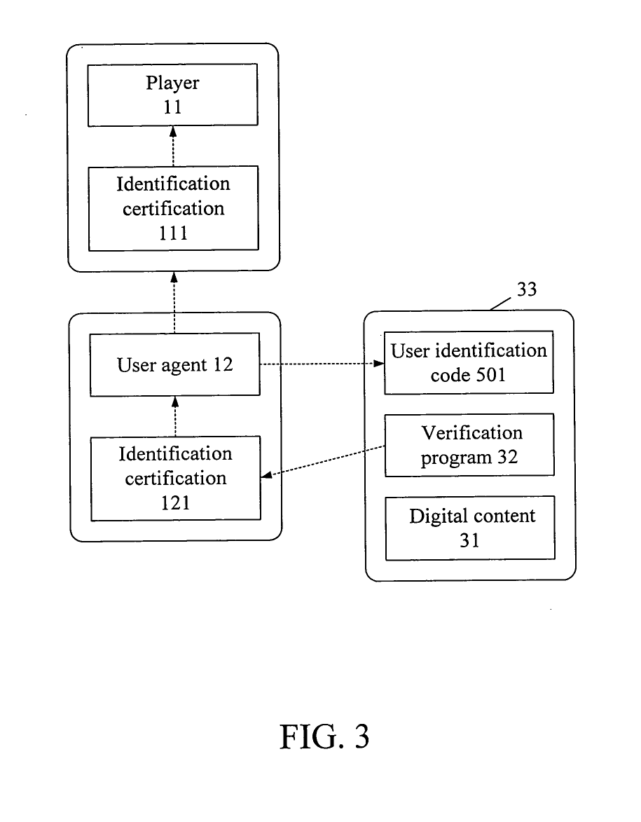

Now, when the end user 5 wants to play or use the digital content 31, the verification program 32 embedded in the digital content 31 is started to perform the identification verification process (step 208). Please refer to FIG. 3. FIG. 3 is a schematic drawing of a verification process of the first embodiment according the present invention. The verification program 32 checks the identification certification 121 of the user agent 12 to verify the validity of the user agent 12. Furthermore, the user agent 12 will also verify the identification certification 111 of the player 11 to ensure the validity of the player 11. The user agent 12 also reads the subscriber identity module (SIM) number stored in the terminating machine of the end user 5 to compare the SIM number with the identification code 501 in the digital content package 33; if they match with each other, the player 11 can execute the digital content 31, otherwise the end user 5 is not qualified to use the digital content 31.

When the above mentioned verification processes are completed, the user agent 12 can use its secret key to decrypt the encrypted package to obtain the digital content 31 (step 209) and limitations (such as playing time, playing frequency, etc.) of the end user 5 according to the right permission content. Finally, the player 11 can play the digital content 31 through the user agent 12 (step 210).

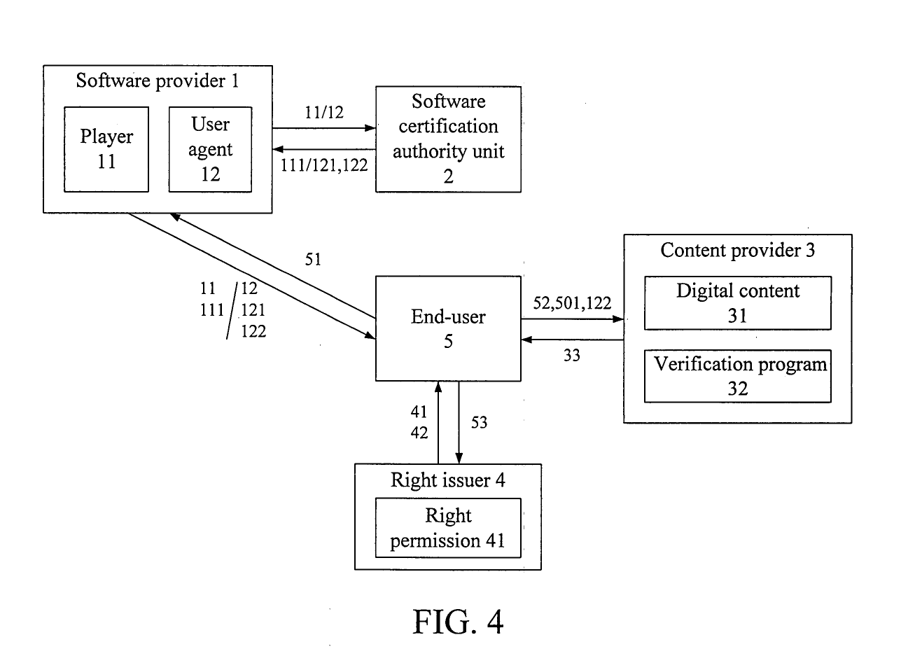

In addition, please refer to FIG. 4. FIG. 4 is a schematic drawing of a practical environment of a second embodiment according to the present invention. In this embodiment, the corresponding flowchart is similar to the first embodiment. In the first embodiment, the end user 5 issues the software download request 51 to the software certification authority unit 2. In this embodiment, however, the end user 5 issues the software download request 51 to the software provider 1. In the other words, in this embodiment, the software certification authority unit 2 sends the player 11, the user agent 12 and their corresponding identification certifications 111, 121, and the user agent public key 122 back to the software provider 1 for storage.

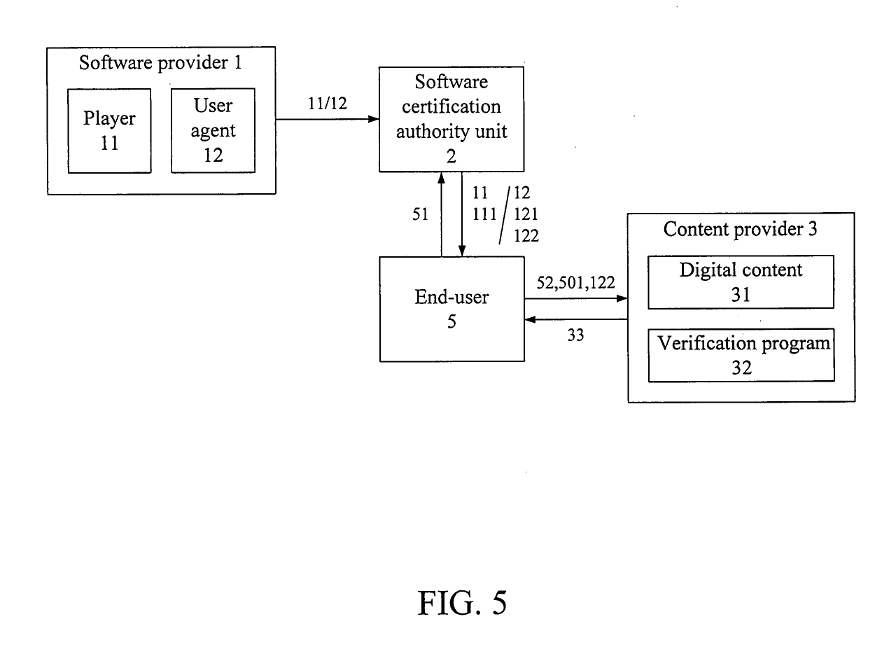

In addition, please refer to FIG. 5. FIG. 5 is a schematic drawing of a practical environment of a third embodiment according to the present invention. In the above-mentioned embodiments, the content provider 3 and the right issuer 4 are two different means; however, in this embodiment, the content provider 3 is also the right issuer 4, so that when the end user 5 sends a digital content download request 52 to the content provider 3, the content provider 3 sends back a digital content package comprising an encrypted package with right permission information, which means the encrypted package is formed by using the UA public key UAₚₖ 122 to encrypt the digital content 31 and the right permission. Therefore, this embodiment can skip steps 205 to step 207 shown in FIG. 2 to simplify the process.

According to the above descriptions, the present invention needs to qualify the identification certification of the player 11, the user agent 12 and the end user 5, and then the user agent 12 in the end user 5 can control the player 11 according to the right permission 41 to play the digital content 31. In this manner, the content provider's rights and interests are protected. Therefore, the end user 5 can only use a valid user agent 12 to present the digital content 31, since the verification program 32 embedded in the digital content 31 will verify the validity of the user agent 12. Since the player 11 is verified, the end user 5 cannot illegally reproduce or spread the digital content 31 after being decrypted because other end users don't have the valid player to play the digital content 31. Furthermore, the digital content 31 is encrypted by the valid user agent public key, so it must be decrypted by the corresponding secret key to obtain correct digital data for the player 11 to play. Moreover, the user agent 12 compares the user identification code 501 in the digital content 31 with that stored with the end user 5; if the digital content gets sent to another user, the identification code 501 will not match, and so the digital content 31 will not be played. Therefore, the digital content protection method provided by the present invention is very strict and safe, which ensures that the digital content 31 provided by the content provider 3 is protected effectively and completely.

Although the present invention has been explained in relation to its preferred embodiment, it is to be understood that many other possible modifications and variations can be made without departing from the spirit and scope of the invention as hereinafter claimed.

1. A digital content protection method applied in a digital rights management (DRM) system, the digital rights management system including a software provider, a software identification certification authority, a content provider, and an end user; the software provider providing at least one player for executing or rendering a digital content, and a user agent for controlling a usage authority for the player and management of a public key and a secret key; the software identification certification authority issuing an identification certification for the player and the user agent and confirming the identity of the player and the user agent; the content provider providing at least one piece of digital content for the end user to download, and the digital content containing an verification program for examining a validity of the player and the user agent; the method comprising:
(A) issuing a software download request for downloading the user agent and its corresponding identification certification;
(B) receiving the user agent, its corresponding identification certification and a public key corresponding to the user agent, wherein the user agent is embedded with a corresponding secret key;
(C) sending a digital content request with a user identity of the user and the public key corresponding to the user agent;
(D) receiving a digital content package comprising an encrypted package, an verification program and a user identification code of the end user, the encrypted package being digital content encrypted according to the public key of the user agent; and
(E) examining the validity of the identification certification of the user agent according to the verification program and the validity identification certification of the player by the user agent, then using the secret key of the user agent to decrypt the encrypted package to combine the digital content with a right permission for regulating a use limitation of the digital content and to be played by the player.

2. The method as claimed in claim 1, wherein a wireless transport layer security (WTLS) is employed to transport information in the digital rights management system.

3. The method as claimed in claim 1, wherein the digital content is valuable digital content.

4. The method as claimed in claim 1, wherein in step (A), the end user sends out the software download request to the software identification certification authority to download the player, the user agent and the corresponding identification certification of the player and the user agent.

5. The method as claimed in claim 1, wherein the software identification certification authority sends back the identification certifications corresponding to the player and the user agent to the software provider for storage.

6. The method as claimed in claim 5, wherein in step (A), the end user sends out the software download request to the software provider to download the player, the user agent and the corresponding identification certification of the player and the user agent.

7. The method as claimed in claim 1, wherein before step (A), the end user has stored the player.

8. The method as claimed in claim 1, wherein in step (A), the software download request further downloads the player and a corresponding identification certification of the player.

9. The method as claimed in claim 1, wherein in step (C), the end user send the digital content download request, the user identification code and the public key of the user agent to the content provider.

10. The method as claimed in claim 9, wherein in step (D), the end user receives the digital content package from the content provider.

11. The method as claimed in claim 1, wherein the user identification code of the end user is a serial number for an identification card.

12. The method as claimed in claim 1, wherein the digital rights management system comprises a right issuer for issuing a right permission to regulate the use limits of authority of the digital content, and the software identification certification authority provides the identification certification of the right issuer.

13. The method as claimed in claim 12 further comprising, before step (E), the following steps:
(F) sending a right download request to the right issuer;
(G) receiving the right permission and an identification certification from the right issuer; and
(H) verifying the validity of the identification certification of the issuer.

14. The method as claimed in claim 1, wherein the content provider issues a right permission to regulate the use limits of authority of the digital content.

15. The method as claimed in claim 14, wherein in step (D), the encrypted package is the digital content and it's a corresponding right permission encrypted by the public key of the user agent.
